(19) United States
(12) Patent Application Publication
(10) Pub. No.: US 2015/0213257 A1
(43) Pub. Date: Jul. 30, 2015

(54) Password Authentication System and Password Authentication Method

(71) Applicant: ACCTON TECHNOLOGY CORPORATION, HSINCHU (TW)

(72) Inventors: Yi-Hsiung LAI, Hsinchu City (TW); Kang-Chang WU, Hsinchu City (TW)

(21) Appl. No.: 14/324,277

(22) Filed: Jul. 7, 2014

(30) Foreign Application Priority Data
Jan. 28, 2014 (TW) 103103234

(51) Int. Cl. G06F 21/45; G06F 21/36; H04L 29/06

(52) U.S. Cl. CPC G06F 21/45; H04L 63/083; G06F 21/36

(57) ABSTRACT

A password authentication system and a password authentication method are disclosed. The password authentication method includes the following steps. An input of first color arranging information is received, and the first color arranging information is selected to select at least one of a plurality of colors from a color menu and arrange the at least one of a plurality of colors. The first color arranging information is converted into first color coding information. A server stores the first color coding information as a color token password. After the color token password is built, the server determines whether authentication information and the color token password match if a client device sends the authentication information to the server. When the authentication information and the color token password match, the client device is validated.

### RELATED APPLICATIONS

This application claims priority to Taiwan Application Serial Number 103103234, filed Jan. 28, 2014, which is herein incorporated by reference.

### BACKGROUND

1. Field of Invention

The present disclosure relates to a password authentication technology. More particularly, the present disclosure relates to a password authentication system and a password authentication method.

2. Description of Related Art

Because secure communication in the Internet is more and more emphasized, requirements of authentication through a password′ becomes more frequently to identify whether a user can execute certain services of interest. In general, the password is set with digits, alphabets, or a combination thereof. There are 36 digits and alphabets in total. At present, many brute-force attack programs are developed to compromise the password, and thus password-hacking news are heard from time to time. On the other hand, it is inconvenient for the user to select an overly complicated password in order to increase the password security.

Most of the present password authentication systems and methods only include the digits and alphabets, which is apt to become a weak point of the password authentication. Therefore, it is one of the most important subjects to apply a great diversity of password setting with great diversity other than the use of the digits and alphabet, which balances the user convenience and the password security.

### SUMMARY

A password authentication system and a password authentication method are provided to resolve the problems met in the art.

According to an embodiment of the present disclosure, the password authentication system comprises a server and a client device. The client device comprises a display module, an input module, a coding module, and a network module. The display module is configured to display a color menu. The input module is configured to accept an input of first color arranging information, wherein the first color arranging information is at least one of colors selected from the color menu to arrange. The coding module is configured to convert the first color arranging information into first color coding information. The network module is configured to transmit the first color coding information to the server so that the server makes the first color coding information serve as a color token password, the server determines whether authentication information and the color token password match if the client device sends the authentication information to the server after the color token password is built, and the client device is validated through the server when the authentication information and the color token password match.

In an embodiment, the first color arranging information is an arrangement of the at least one of the colors according to at least one of the sequence, the combination, the tuning ratio, the shape, and the location of the at least one of the colors.

In an embodiment, the client device further comprises a transmission interface module configured to connect to an external device, wherein the external device stores the authentication information, the network module transmits the authentication information to the server, and the client device is allowed to access a device under test (DUT) when the client device is validated through the server.

According to an embodiment of the present disclosure, the password authentication system comprises a server and a client device. The server comprises a display module, an input module, a coding module, and a storage module. The display module is configured to display a color menu. The input module is configured to accept an input of first color arranging information, wherein the first color arranging information is to select at least one of a plurality of colors from the color menu and arrange the at least one of a plurality of colors. The coding module is configured to convert the first color arranging information into first color coding information. The storage module is configured to store the first color coding information as a color token password, the server determining whether authentication information and the color token password match if the client device sends the authentication information to the server after the color token password is built, and the client device is validated through the server when the authentication information and the color token password match.

In an embodiment, the client device sends the authentication information to the server if the client device connects to an external device storing the authentication information after the color token password is built by the server, and the client device is allowed to access a device under test (DUT) when the client device is validated through the server.

According to an embodiment of the present disclosure, the password authentication method comprises: accepting an input of first color arranging information, wherein the first color arranging information is to select at least one of a plurality of colors from the color menu and arrange the at least one of a plurality of colors; converting the first color arranging information into first color coding information; storing the first color coding information as a color token password via a server; and determining whether authentication information and the color token password match via the server if a client device sends the authentication information to the server after the color token password is built, and the client device is validated through the server when the authentication information and the color token password match.

In an embodiment, the password authentication method further comprises: converting second color arranging information into second color coding information served as the authentication information to send to the server if the client device accepts an input of the second color arranging information after the color token password is built by the server, and the client device is validated through the server to access a device under test (DUT) when the second color coding information and the color token password match.

In summary, the present disclosure has significant advantages and higher performance than current technology. With the present disclosure, we have significant improvement in password authentication techniques, and it is worthwhile to increase the difficulty for cracking the password via a great diversity of a password setting method excluding any number and alphabet because a quantity of colors may include more different selection depends on a definition of the colors. For example as bitmap, the quantity of the colors may be 2 colors (1 bit), 4 colors (2 bits), 8 colors (3 bits), 16 colors (4 bits), 256 colors (8 bits), even 65536 colors (16 bits) to select and set. A variability is generated by combining the plurality of colors (e.g., the combination of a yellow color and a blue color is a green color), a tuning ratio of the plurality of colors, a shape of the plurality of colors, and a location of the plurality of colors. The variability of a password can be promoted so that the password is not compromised easily. The present disclosure not only uses the colors as a interface for the password selecting and setting to promote the extent of secrecy but also provides the users a more friendly and easy operation so that a multifarious and tedious password is need to input.

### BRIEF DESCRIPTION OF THE DRAWINGS

The invention can be more fully understood by reading the following detailed description of the embodiment, with reference made to the accompanying drawings as follows:

FIG. 1 is a block diagram of a password authentication system according to an embodiment of the present disclosure;

FIG. 2 is a block diagram of a password authentication system according to another embodiment of the present disclosure;

FIG. 3 is a schematic diagram of a color menu in the password authentication system according to an embodiment of the present disclosure;

FIG. 4A-4D are schematic diagrams of first/second arranging information in the password authentication system according to an embodiment of the present disclosure;

FIG. 5 is a flow chart of a password authentication method according to an embodiment of the present disclosure; and

FIG. 6 is a flow chart of a subsequent process of a password authentication method when second color coding information and the color token password do not match according to an embodiment of the present disclosure.

### DETAILED DESCRIPTION

Reference will now be made in detail to the present embodiments of the disclosure, examples of which are illustrated in the accompanying drawings. Wherever possible, the same reference numbers are used in the drawings and the description to refer to the same or like parts. In addition, the well-known components and steps are not described in the embodiments to avoid unnecessary limitations to the present disclosure.

A password authentication system and a password authentication method according to the present disclosure are to convert a color arranging information set by a user or a system manager into a color coding information and then store the color coding information as a color token password in a server. When a client device would like to access a DUT through a network, the server determines whether authentication information and the color token password match to identify whether the client device can access the DUT. The present disclosure does not limit the type of the DUT. The DUT may be a physical device, e.g., a computer. Alternatively, the DUT may be a server that provides a relative service, e.g., the server provides a personal email service.

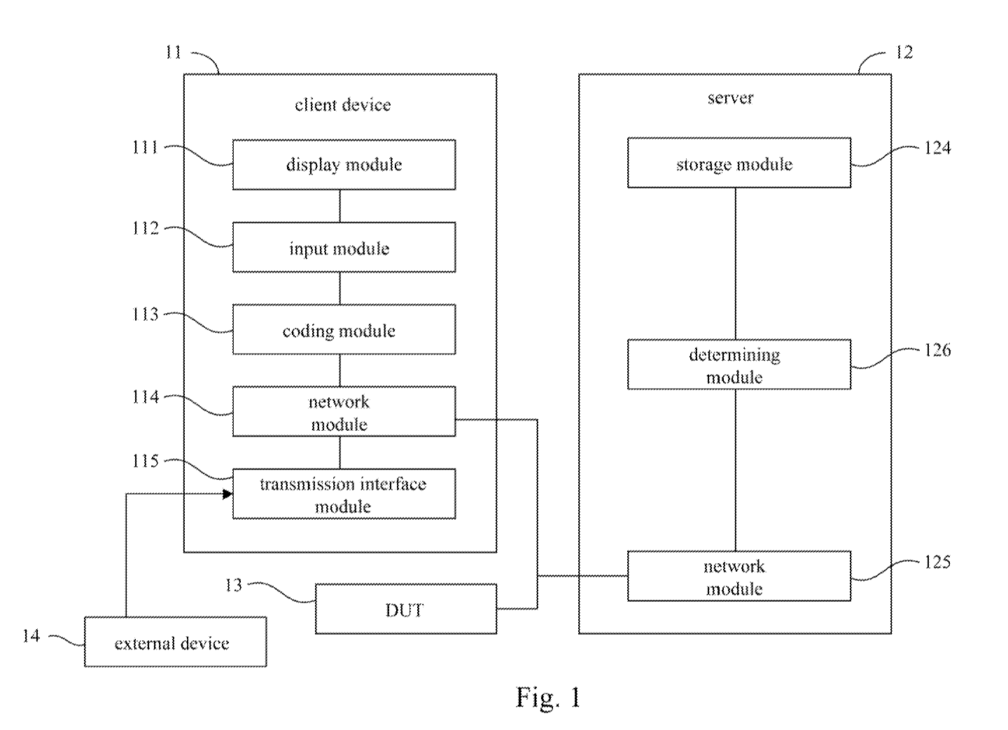

FIG. 1 is a block diagram of a password authentication system according to an embodiment of the present disclosure. As shown in FIG. 1, the password authentication system includes a client device 11 and a server 12. The client device 11 includes a display module 111, an input module 112, a coding module 113, a network module 114, and a transmission interface module 115. The server 12 includes a storage module 124, a network module 125, and a determining module 126. Wherein the client device 11 and the server 12 are network connected by the connection between the network module 125 and the network module 114, and the DUT 13 is respectively connected to the network module 114 and the network module 125 through the network.

When the user inputs the color arranging information to the client device 11 so that the color token password which is relative to the color arranging information is built in the server 12, the display module 111 displays a color menu that is provided to the user for selecting colors serve as a password. The user may input first color arranging information through the input module 112, and the input module 112 accepts an input of the first color arranging information. The first color arranging information is to select at least one of a plurality of colors from the color menu and arrange the at least one of a plurality of colors. For example as bitmap, when a color depth is 3 bits, there are 2³ (i.e., 8) colors in the color menu to be selected. By analogy, when a color depth is 4 bits, there are 2⁴ (i.e., 16) colors in the color menu to be selected; when a color depth is 8 bits, there are 2⁸ (i.e., 256) colors in the color menu to be selected. Both the color definition and the color depth may be flexibly selected, and the present disclosure does not limit the embodiments as mentioned above. Each of the colors has a corresponding color code. The first color arranging information is finished after the at least one of the plurality of colors is selected by the user, even the selected color(s) can be ranked and/or combined in the color menu, the tuning ratio of the selected color(s) can be tuned, and the shape of the selected color(s) or the specific location of the selected color(s) can be set. The first color arranging information includes attributes of the plurality of colors, e.g., each color code of the plurality of colors, otherwise, the sequence of the plurality of colors, the combination result of the plurality of colors, the tuning ratio of the plurality of colors, the shape of the plurality of colors, or the location of the plurality of colors are corresponding to the relative attribute code.

When the input module 112 receives the first color arranging information input by the user, the coding module 113 converts the first color arranging information into the first color coding information according to the color code and the attribute code in the first color arranging information, and then the coding module 113 transmits the first color coding information to the network module 125 of the server 12 through the network module 114. After the network module 125 receives the first color coding information, the determining module 126 will determine a source and a format of the first color coding information, take the first color coding information to serve as the color token password, and store the color token password in the storage module 124. The present disclosure does not limit the method about converting the first color arranging information into the first color coding information. The first color arranging information may be the first color coding information directly. Alternatively, the first color coding information is also a result after the first color arranging information is processed, e.g., encoding and compressing.

In an embodiment, when the transmission interface module 115 is connected to an external device 14, the transmission interface module 115 transmits the first color coding information to the external device 14 and stores the first color coding information as authentication information. When the user will access the DUT 13 from the client device 11 thereafter, the client device 11 is validated through the server 12 by the authentication information in the external device 14 connected to the client device 11 directly and then accesses the DUT 13. The user does not need to input the color arranging information through the input module 112 again.

When the color token password is built in the server 12, the authentication information will be transmitted to the DUT 13 through the network module 114 once the user will access the DUT 13 through the client device 11 by the authentication information, and the DUT 13 will request the determining module 126 to validate through the network module 125. When the determining module 126 receives the authentication information, the determining module 126 will determine whether the authentication information and the color token password match. When the authentication information and the color token password match, the client device 11 that transmits the authentication information is validated through the server 12 so that the client device 11 can access the DUT 13 through the network module 114.

Conversely, when the authentication information that is requested the determining module 126 to validate through the network module 125 by the DUT 13 does not match the color token password in the storage module 124, and when the number of unmatched times continuously exceeds a predetermined number (e.g., 3), the DUT 13 will send a warning message (e.g., email) to the server 12 to remind an administrator of the server 12 to pay attention that the user of the client device 11 uses wrong authentication information to access the DUT 13. At this time, the display module 114 will show a warning screen to remind the user of the client device 11 that the authentication information is wrong. The determining module 126 will also record a MAC address of the client device 11 and store the MAC address of the client device 11 in the storage module 124 so as to stop the client device 11 requesting to access the DUT 13 by any authentication information to avoid that the DUT 13 is invaded maliciously. As long as the administrator of the server 12 does not remove the MAC address of the client device 11 from the storage module 124, the client device 11 cannot access the DUT 13 by any authentication information.

When the administrator of the server 12 removes the MAC address of the client device 11 from the storage module 124, the client device 11 can just request to access the DUT 13 by another authentication information. The DUT 13 just requests the determining module 126 to validate through the network module 125, and the determining module 126 determines whether another authentication information received by the determining module 126 is validated.

The authentication information as mentioned above may be converted from a second color arranging information received by the input module 112. The input module 112 is configured to accept an input of the second color arranging information, wherein the second color arranging information is the similar to the first color arranging information that is to select at least one of the plurality of colors from the color menu and arrange the at least one of a plurality of colors. Likewise the second color arranging information includes attributes of the plurality of colors. The coding module 113 converts the second color arranging information into second color coding information according to a color code and an attribute code in the second color arranging information, takes the second color arranging information to serve as the authentication information, and transmits the second color coding information to the network module 125 of the server 12 through the network module 114.

Alternatively, the client device 11 can be externally connected to the external device 14 through the transmission interface module 115 to import the authentication information stored in the external device 14 to the client device 11. The transmission interface module 115 connects to the external device 14, the authentication information stored in the external device 14 can be imported to the client device 11 through the external device 14 by either the user or the administrator, and the external device 14 transmits the authentication information to the network module 125 of the server 12.

The determining module 126 can determine an authority of the client device 11 for accessing the DUT 13 by the authentication information. For example, when the user takes the authentication information to validate through the server 12, the user can execute the authority that cannot change a setting and a content of the DUT 13, e.g., to review files in the DUT 13, to download the files in the DUT 13. When the administrator takes the authentication information to validate through the server 12, the administrator can execute the authority that can change the setting and the content of the DUT 13, e.g., to modify the setting of the DUT 13, to upload the files to the DUT 13.

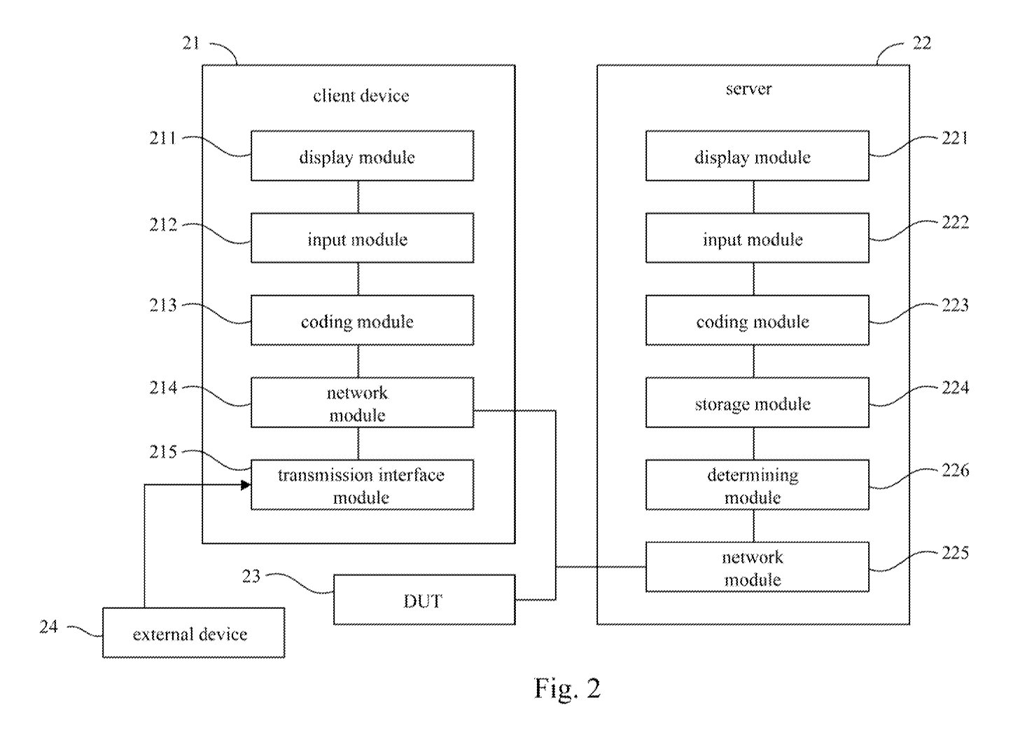

On the other hand, the administrator can input the color arranging information in the server 12 to build a color token password corresponding to the color arranging information. FIG. 2 is a block diagram of a password authentication system according to another embodiment of the present disclosure. As shown in FIG. 2, the password authentication system includes a client device 21 and a server 22. The client device 21 includes a display module 211, an input module 212, a coding module 213, a network module 214, and a transmission interface module 215. The server 22 includes a display module 221 an input module 222, a coding module 223, a storage module 224, a network module 225, and a determining module 226. The client device 21 and the server 22 are network connected through the network module 214 and the network module 225, and the DUT 23 is connected to the network module 214 and the network module 225 by the network respectively.

In an embodiment, when the administrator inputs color arrange information in the server 22 so as to build a color token password in the server 22, the display module 221 displays a color menu and accepts an input of first color arranging information, wherein the first color arranging information is to select at least one of a plurality of colors from the color menu and arrange the at least one of a plurality of colors. When the input module 222 receives the first color arranging information input by the administrator, the coding module 223 converts the first color arranging information into first color coding information according to a color code and an attribute code of the first color arranging information, appends a corresponding authority that the administrator accesses the DUT 23 to the first color coding information, takes the first color coding information to serve as the color token password, and stores the color token password in the storage module 224. The present disclosure does not limit a method as mentioned above to convert the first color arranging information into the first color coding information.

In an embodiment, the first color coding information may be transmitted to an external device 24 and stored as the authentication information. When the administrator connects the external device 24 to the transmission interface module 215, the administrator may take the authentication information in the external device 24 to validate through the server 22 in the client device 21, not need to input the color arranging information in the input module 212 again. That's why that the administrator may be in the administrator capacity and take the corresponding authentication information to access the DUT 23 through the client device 21 except for the server 22.

When the color token password is built in the server 22, the administrator may send the authentication information in the client device 21 to the server 22 through the network module 214 and the network module 225. When the determining module 226 receives the authentication information, the determining module 226 may determine whether the authentication information and the color token password in the storage module 224 match. Regarding the determining module 226 determines whether the authentication information and the color token password in the storage module 224 match, further elaboration is not provided since the above embodiments have been specifically disclosed.

The authentication information as mentioned above may receive the second color arranging information through the input module 212 to convert the second color arranging information and serve as the authentication information. Alternatively, the authentication information may be externally connected to the external device 24 through the transmission interface module 215 to import the authentication information stored in the external device 24 to the client device 21. Since the above embodiments have been specifically disclosed, further elaboration is not provided.

The display module 111, 211, 221 as mentioned above may be an audio/video output interface or a like device, e.g., a display, a monitor. The input module 112, 212, 222 may be a device to directly or indirectly accept the input of the first/second color arranging information, e.g., a mouse, a keyboard, a scanner, an image sensor, or a touch panel. A feasible embodiment may be a combination with the display and the mouse to select the color arranging information in the display. Alternatively, the feasible embodiment may read a specific color card by the scanner or the image sensor to get the color arranging information. The network modules 114, 125, 214, 225 may be a wireless telecommunication module, a 3G communication module, a 4G communication module, or a wire network communication module. The transmission interface modules 115, 215 can be connected to the external devices 14, 24. For example, when the transmission interface modules 115, 215 are plugging interfaces of USB, the external devices 14, 24 may be devices with USB, e.g., fresh disks, external disks. The storage modules 124, 224 may be devices or equipments with storing function, e.g., physical databases and cloud databases. The present disclosure does not limit the devices that are disclosed as mentioned above.

The coding modules 113, 213, 223 and the determining modules 126, 226 may be specifically implemented in software, hardware, and/or firmware. For example, if the operating speed and precision are both the first considerations, these modules may be CPUs. If design flexibility is the first consideration, these modules are mainly implemented in software. Alternatively, these modules operate with the collaboration of software, hardware, and firmware. It should be understood that none of the above examples is more preferable than any of the other examples, nor are they intended to limit the scope of the disclosure. Those skilled in the art may specifically implement these modules with flexibility according to the requirements then.

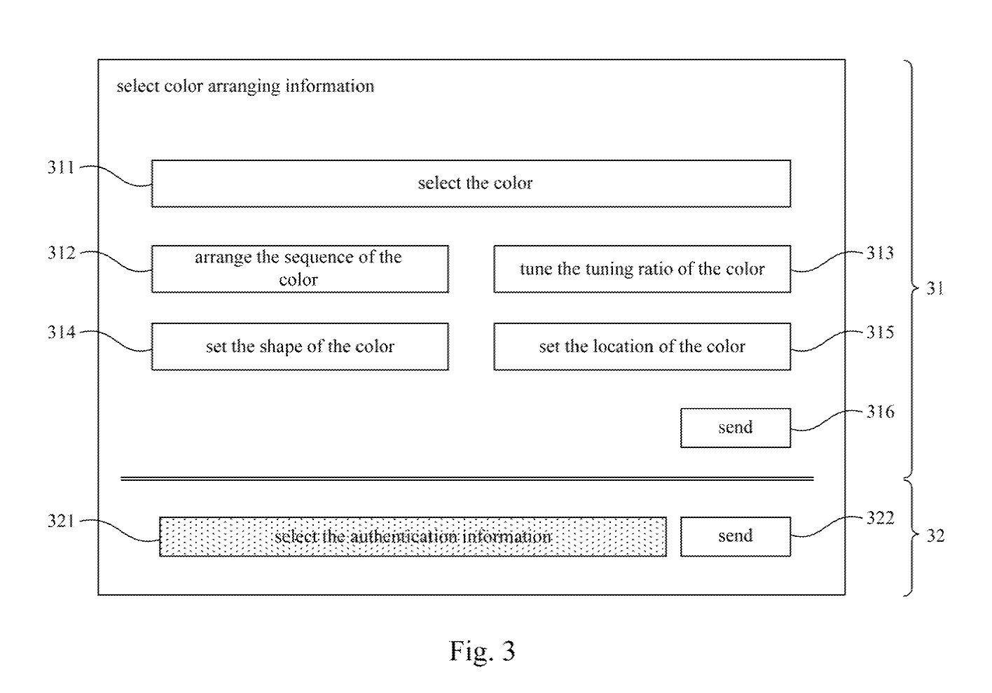

FIG. 3 is a schematic diagram of a color menu in the password authentication system according to an embodiment of the present disclosure. As shown in FIG. 3, the color arranging information can be set in the color menu 31. For example, an option 311 is configured to select the plurality of colors, an option 312 is configured to arrange the sequence of the plurality of colors, an option 313 is configured to tune the tuning ratio of the plurality of colors, an option 314 is configured to set the shape of the plurality of colors, and an option 315 is configured to set the location of the plurality of colors. The first/second color arranging information arranged from the option 311-315 is accepted through the input module, sent through the option 316, and converted into the first/second color coding information.

When the transmission interface module is connected to the external device, an authentication data select frame 32 can accept the authentication information stored in the external device in, import the authentication information through an option 321, and send the authentication information through an option 322 so that the client device transmits the authentication information to the server.

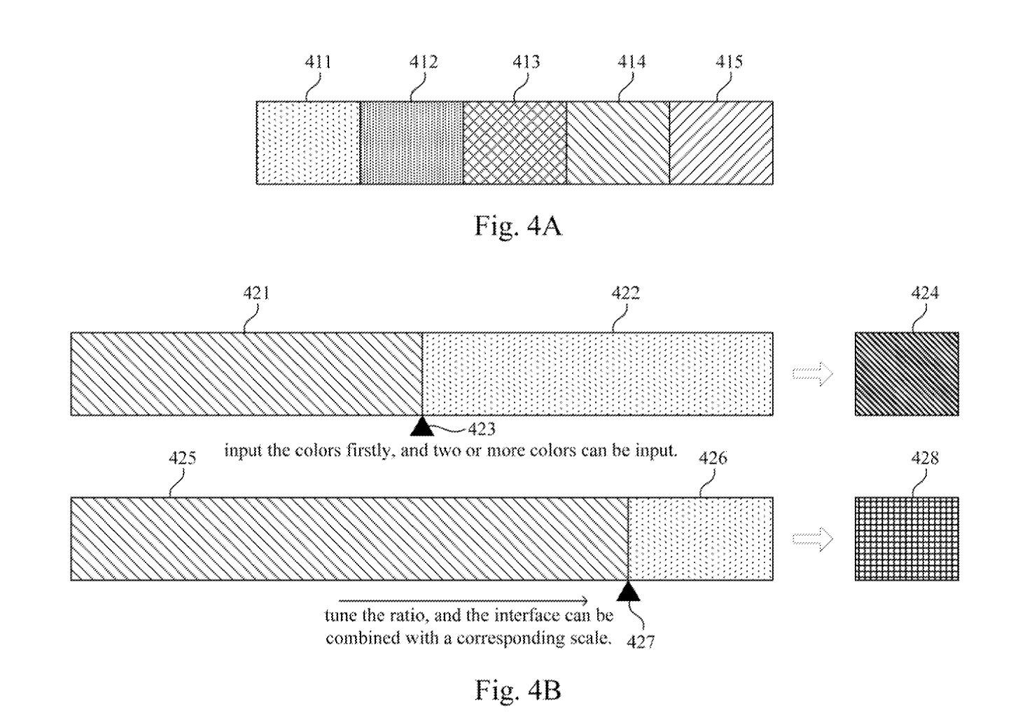

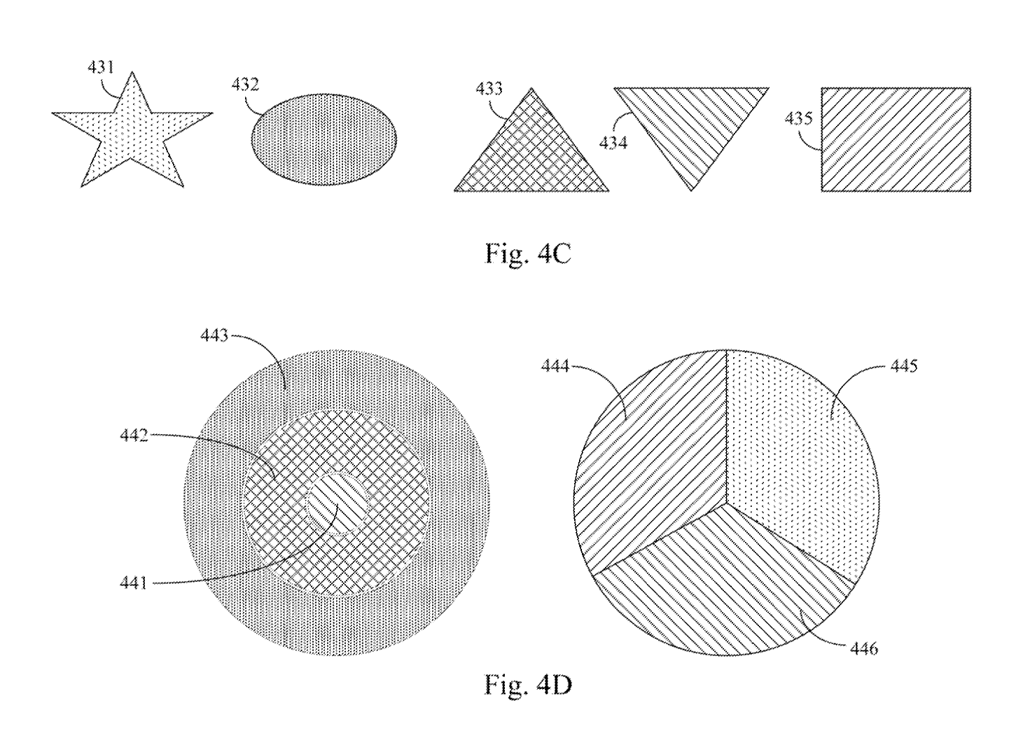

FIGS. 4A-4D are schematic diagrams of first/second arranging information in the password authentication system according to an embodiment of the present disclosure. Wherein FIG. 4A is a schematic diagram of selecting a plurality of colors to arrange the plurality of colors in order; FIG. 4B is a schematic diagram of selecting a plurality of colors to tune a tuning ratio of the plurality of colors; FIG. 4C is a schematic diagram of selecting a plurality of colors to select shapes of the plurality of colors; FIG. 4D is a schematic diagram of selecting a plurality of colors to set specific locations of the plurality of colors.

As shown in FIG. 4A, the user or the administrator selects total 5 colors, i.e., a color 411, a color 412, a color 413, a color 414, and a color 415, from the color menu and then ranks the 5 colors in sequence, and arranging information of the 5 colors is formed. Wherein the arranging information includes attributes about color codes and ranking sequence of the 5 colors, i.e., the color 411, the color 412, the color 413, the color 414, and the color 415.

As shown in FIG. 4B, the user or the administrator selects the plurality of colors from the color menu firstly and then selects two or more from the plurality of colors to tune the tuning ratio. For example, a color 421 and a color 422 are selected firstly, a tuning indicator 423 is moved so that the color 421 and the color 422 are accounted for 50% respectively, and then a color 424 is formed. If a color 425 and the color 426 are selected, and if a tuning indicator 427 is moved so that a color 425 and a color 426 are accounted for 75% and 25% respectively, a color 428 is formed. After finishing the color tuning, the color 424 or the color 428 is ranked with other selected colors to form the arranging information, wherein the arranging information includes the attributes about color codes and ranking of all colors. In other feasible embodiments, a number of colors tuned the tuning ratio does not be limited 2 colors, and the number of colors may be the plurality of colors to mix. In addition, to tune the color ratio in according to embodiments of the present disclosure, the tuning of the color ratio can be specified in a single color. Parameters of a general color can be simply classified a hue parameter, a saturation parameter, and a lightness/brightness parameter. Therefore, under selecting the single color, the present disclosure can also tune the ratio or content of the relative parameter to form the arranging information.

As shown in FIG. 4C, the user or the administrator selects total 5 colors, i.e., a color 431, a color 432, a color 433, a color 434, and a color 435. The user or the administrator even may tune the tuning ratio of the colors to get other colors as shown in FIG. 4B. In addition to rank the sequence of the colors, the user or the administrator may set the shape of the colors (e.g., the color 431 is set as a star shape, the color 432 is set as an ellipse shape, the color 433 is set as a triangle shape, the color 434 is set as an inverted triangle shape, and the color 435 is set as a quadrangle shape) to form the arranging information, wherein the arranging information includes the color codes of all colors and the attributes about the sequence and the shape of all colors.

As shown in FIG. 4D, the user or the administrator selects the plurality of colors from the color menu firstly and then sets the specific locations belonged to the plurality of colors. For example, a color 441, a color 442, and a color 443 are set to put and merge to three concentric circles that are different sizes. Alternatively, a color 444, a color 445, and a color 446 are set to three 120° sectors that are merged to a circle. The selected colors and the locations of the selected colors may be formed the arranging information, wherein the arranging information includes the color codes of all colors and the attributes about the sequence and the shape of all colors.

As mentioned previously, FIG. 4A-4D are schematic diagrams of the different arranging information in the password authentication system according to embodiments of the present disclosure. It should be understood that none of the above embodiments is more preferable than any of the other examples, nor are they intended to limit the scope of the disclosure. In general, after selecting the plurality of colors, arranging the sequence of the colors, tuning the color ratio, setting the shape of the colors, and setting the location or the relative setting of the colors belong to the protective range of the present disclosure. Those skilled in the art may specifically implement these modules with flexibility according to the requirements then.

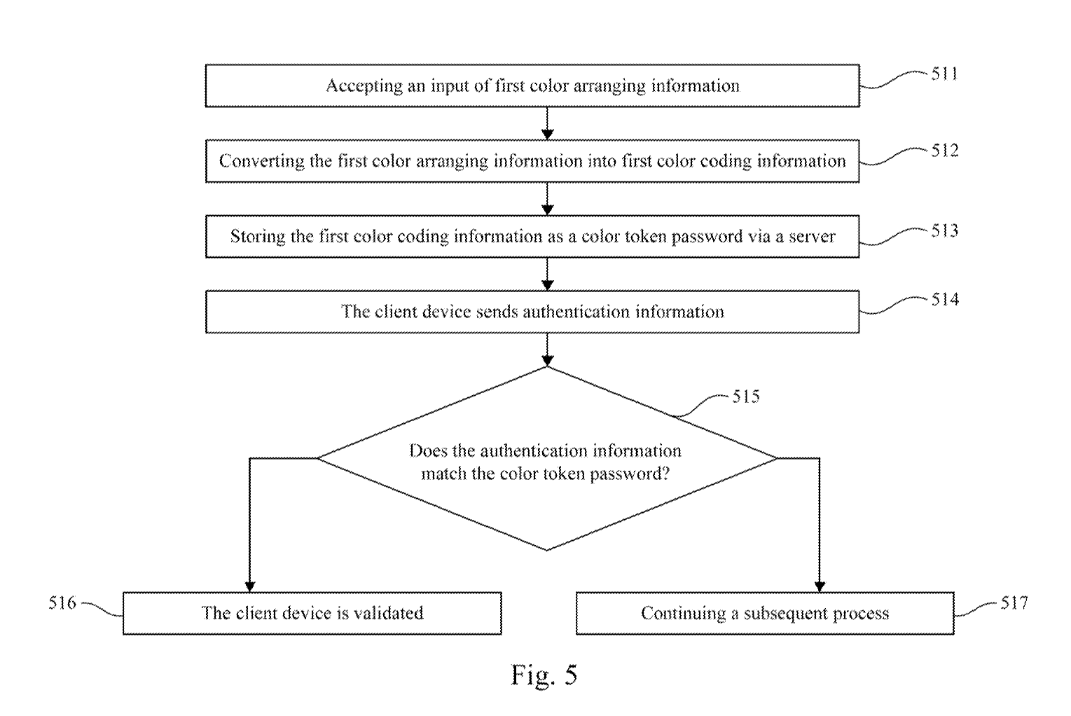

FIG. 5 is a flow chart of a password authentication method according to an embodiment of the present disclosure. As shown in FIG. 5, the password authentication method comprises steps 511-517 (it should be understood that the order of the steps mentioned in the present embodiment may be changed based on actual requirement unless otherwise specified, or the steps may even be performed simultaneously or part of the steps may even be performed simultaneously). Since the hardware devices for implementing these steps have been specifically disclosed in the above embodiments, further elaboration is not provided.

In step 511, accepting an input of first color arranging information. The first color arranging information is to select at least one of a plurality of colors from the color menu and then to accept the sequence of the plurality of colors, the tuning ratio of the plurality of colors, the shape of the plurality of colors, or the location of the plurality of colors. Arranging information of the plurality of colors is formed from a color code of each of the plurality of colors and an attribute code relative to the sequence of the plurality of colors, the color combination of the plurality of colors, the tuning ratio of the plurality of colors, the shape of the plurality of colors, and the location of the plurality of colors. In step 512, converting the first color arranging information into first color coding information. In step 513, storing the first color coding information as a color token password via a server. If the first color coding information is generated in the server, an authority of an administrator for accessing a DUT is appended to the color token password.

When the color token password is built in the server, a user or the administrator may request to access the DUT by authentication information in a client device in step 514. In step 515, if the client device sends the authentication information to the server, the authentication information is determined whether it is matched with the color token password via the server. If the authentication information and the color token password match, the client device is validated to access the DUT by the authentication information in step 516. On the other hand, if the authentication information does not match the color token password, and if the number of unmatched times continuously exceeds a predetermined number (e.g., 3), a subsequent process will be continued in step 517.

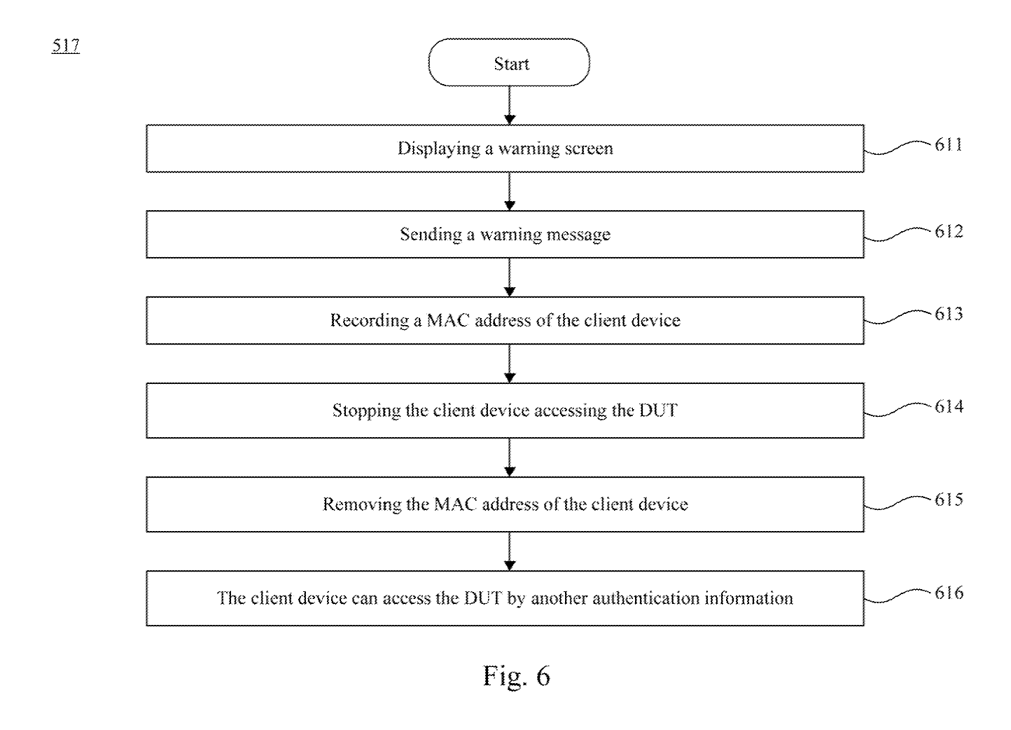

FIG. 6 is a flow chart of a subsequent process of a password authentication method when second color coding information does not match the color token password according to an embodiment of the present disclosure. In step 611, a warning screen is displayed in the client device that sends the authentication information to remind the user of the client device that the authentication information is wrong. In step 612, a warning message (e.g., email) is sent to remind an administrator of the server to pay attention that the user of the client device tries to use wrong authentication information to access the DUT. In step 613, a MAC address of the client device is recorded. In step 614, the MAC address is stored to stop the client device requesting to access the DUT by any authentication information to avoid that the DUT is invaded maliciously.

When the MAC address is removed in step 615, the client device can just request to access the DUT by another authentication information again in step 616, the DUT is requested to validate by the another authentication information, and the another authentication information is determined whether it can be validated.

The present disclosure provides higher extent of security protection by the diversity and variability of the colors compared to the traditional skill of the password combining the numbers and the alphabet. Moreover, the convenient when the user operates is given consideration by every kind of interface designs. Although the present disclosure has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present disclosure without departing from the scope or spirit of the disclosure. In view of the foregoing, it is intended that the present disclosure cover modifications and variations of this disclosure provided they fall within the scope of the following claims.

What is claimed is:

1. A password authentication system, comprising:
a server; and
a client device, comprising:
a display module configured to display a color menu;
an input module configured to accept an input of a first color arranging information, wherein the first color arranging information is to select at least one of a plurality of colors from the color menu and arrange the at least one of a plurality of colors;
a coding module configured to convert the first color arranging information into a first color coding information; and
a network module configured to transmit the first color coding information to the server so that the server makes the first color coding information serve as a color token password, the server determines whether an authentication information and the color token password match if the client device sends the authentication information to the server after the color token password is built, and the client device is validated through the server when the authentication information and the color token password match.

2. The password authentication system of claim 1, wherein the first color arranging information is an arrangement of the at least one of the colors according to at least one of the sequence, the combination, the tuning ratio, the shape, and the location of at least one of the colors.

3. The password authentication system of claim 1, wherein the client device further comprises:
a transmission interface module configured to connect to an external device, wherein the external device stores the authentication information, the network module transmits the authentication information to the server, and the client device is allowed to access a device under test (DUT) when the client device is validated through the server.

4. A password authentication system, comprising:
a client device; and
a server, comprising:
a display module configured to display a color menu;
an input module configured to accept an input of a first color arranging information, wherein the first color arranging information is to select at least one of a plurality of colors from the color menu and arrange the at least one of a plurality of colors;
a coding module configured to convert the first color arranging information into a first color coding information; and
a storage module configured to store the first color coding information as a color token password, the server determining whether an authentication information and the color token password match if the client device sends the authentication information to the server after the color token password is built, and the client device is validated through the server when the authentication information and the color token password match.

5. The password authentication system of claim 4, wherein the first color arranging information is an arrangement of the at least one of the colors according to at least one of the sequence, the combination, the tuning ratio, the shape, and the location of at least one of the colors.

6. The password authentication system of claim 4, wherein the client device sends the authentication information to the server if the client device connects to an external device storing the authentication information after the color token password is built by the server, and the client device is allowed to access a device under test (DUT) when the client device is validated through the server.

7. A password authentication method, comprising:
accepting an input of a first color arranging information, wherein the first color arranging information is to select at least one of a plurality of colors from a color menu and arrange the at least one of a plurality of colors;
converting the first color arranging information into a first color coding information;
storing the first color coding information as a color token password via a server; and
determining whether an authentication information and the color token password match via the server if a client device sends the authentication information to the server after the color token password is built, and the client device is validated through the server when the authentication information and the color token password match.

8. The password authentication method of claim 7, wherein the first color arranging information is an arrangement of the at least one of the colors according to at least one of the sequence, the combination, the tuning ratio, the shape, and the location of at least one of the colors.

9. The password authentication method of claim 7, further comprising:
converting a second color arranging information into a second color coding information served as the authentication information to send to the server if the client device accepts an input of the second color arranging information after the color token password is built by the server, and the client device is validated through the server to access a device under test (DUT) when the second color coding information and the color token password match.

10. The password authentication method of claim 7, further comprising:
sending the authentication information stored in an external device to the server through the client device if the client device connects to the external device after the color token password is built by the server, and the client device is allowed to access a device under test (DUT) when the client device is validated through the server.
